(19) United States
(12) Patent Application Publication
(10) Pub. No.: US 2015/0186033 A1
(43) Pub. Date: Jul. 2, 2015

(54) GLASSES TYPE DEVICE WITH OPERATING MEANS ON RIM AND USER INPUT METHOD USING THE SAME

(71) Applicant: KOREA ELECTRONICS TECHNOLOGY INSTITUTE, Seongnam-si (KR)

(72) Inventors: Kyoung Won MIN, Seongnam-si (KR); Haeng Seon SON, Seongnam-si (KR); Seon Young LEE, Seoul (KR)

(73) Assignee: KOREA ELECTRONICS TECHNOLOGY INSTITUTE, Seongnam-si (KR)

(21) Appl. No.: 14/583,881

(22) Filed: Dec. 29, 2014

(30) Foreign Application Priority Data
Dec. 31, 2013 (KR) 10-2013-0168086

(51) Int. Cl. G06F 3/0488; G02B 27/01; G06F 3/041

(52) U.S. Cl. CPC G06F 3/04883; G06F 3/041; G02B 27/017; G02B 2027/0178

(57) ABSTRACT

A glasses type device with an operating means on a rim and a user input method using the same are provided. The glasses type device includes: a touch sensor provided on a rim of a frame of a glasses shape; and a processor configured to process a user operation which is input through the touch sensor. Accordingly, the touch sensors for inputting a user operation are located on the rim of the glasses frame for fixing lenses, so that intuitive various user operations can be performed.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Dec. 31, 2013, and assigned Serial No. 10-2013-0168086, the entire disclosure of which is hereby incorporated by reference.

### TECHNICAL FIELD OF THE INVENTION

The present invention relates generally to a user input method, and more particularly, to a glasses type device and a user input method using the same.

### BACKGROUND OF THE INVENTION

Since glasses type devices are not equipped with a specific user input device, users have a limit to operating an application projected onto a see-through glass placed in front of users' eyes.

A controller of a remote control type has been used for user input for the glasses type device. In this case, however, there is inconvenience that the user should carry a separate device in addition to the glasses type device.

In addition, the user input by the controller of the remote control type is not intuitive and thus this method is not preferred by the users. In addition, the addition of the separate device may cause the product cost to increase.

### SUMMARY OF THE INVENTION

To address the above-discussed deficiencies of the prior art, it is a primary aspect of the present invention to provide a glasses type device which includes touch sensors located on a rim of a glasses frame for fixing lenses, and a user input method using the same.

According to one aspect of the present invention, a glasses type device includes: a frame of a glasses shape; a touch sensor provided on a rim of the frame; and a processor configured to process a user operation which is input through the touch sensor.

The touch sensor may include: a first touch sensor provided on a first rim; and a second touch sensor provided on a second rim.

The user operation may include an operation of touching at least one of the first touch sensor and the second touch sensor and an operation of touching and dragging at least one of the first touch sensor and the second touch sensor.

The first touch sensor may include: a 11^{th} sensor provided on an upper portion of the first rim; and a 12^{th} touch sensor provided on a lower portion of the first rim.

The user operation may include an operation of pinching the 11^{th} touch sensor and the 12^{th} touch sensor with one hand and then dragging.

The second touch sensor may include: a 21^{st} touch sensor provided on an upper portion of the second rim; and a 22^{nd} touch sensor provided on a lower portion of the second rim.

The user operation may include an operation of pinching the 11^{th} touch sensor and the 12^{th} touch sensor with one hand and pinching the 21^{st} touch sensor and 22^{nd} touch sensor with the other hand, and then dragging at least one of the both hands.

The user operation may include an operation of touching one of the 11^{th} touch sensor and the 12^{th} touch sensor with one hand and touching one of the 21^{st} touch sensor and the 22^{nd} touch sensor with the other hand, and then dragging at least one of the both hands.

According to another aspect of the present invention, a user input method includes: receiving a user operation through a touch sensor provided on a rim of a frame of a glasses shape; and processing the received user operation.

As described above, according to exemplary embodiments of the present invention, touch sensors for inputting a user operation are located on the rim of the glasses frame for fixing lenses, so that intuitive various user operations can be performed.

In addition, according to exemplary embodiments of the present invention, the glasses frame can be prevented from shaking by the pinch operation, and, since many touch sensors can be provided, various inputs can be achieved by various combinations.

In addition, according to exemplary embodiments of the present invention, since the whole design of the glasses is not changed, the glasses frame is not defaced and the design is not limited.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view showing an exterior of a glasses type device according to an exemplary embodiment of the present invention;

FIG. 2 is a plane view of the glasses type device of FIG. 1, viewed from the top;

FIG. 3 is a bottom view of the glasses type device of FIG. 1, viewed from the bottom;

FIG. 4 is a view showing a one hand pinch and drag (P&D) operation;

FIG. 5 is a view showing a both hands P&D operation;

FIG. 6 is a view showing a one hand touch and drag (T&D) operation;

FIG. 7 is a view showing a both hands T&D operation; and

FIG. 8 is a block diagram of an interior of the glasses type device of FIG. 1.

### DETAILED DESCRIPTION OF THE INVENTION

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

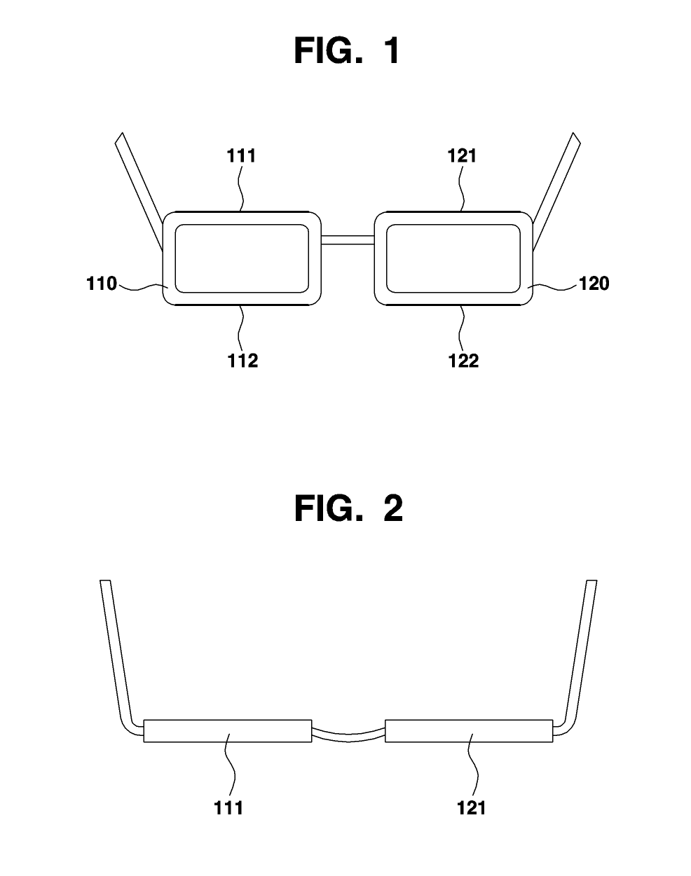

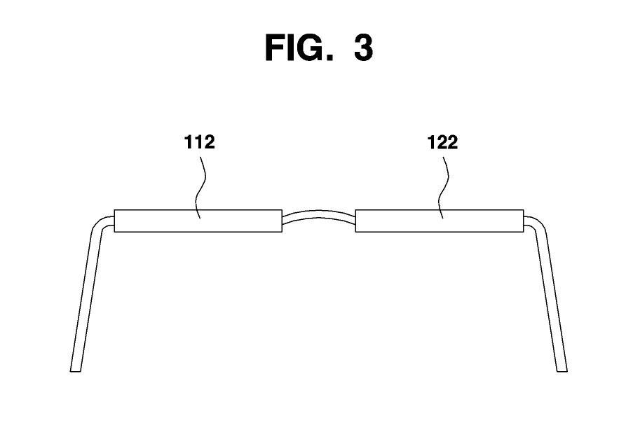

FIG. 1 is a perspective view showing an exterior of a glasses type device according to an exemplary embodiment of the present invention, FIG. 2 is a plane view of the glasses type device of FIG. 1, viewed from the top, and FIG. 3 is a bottom view of the glasses type device of FIG. 1, viewed from the bottom.

As shown in FIGS. 1 to 3, the glasses type device according to an exemplary embodiment of the present invention includes touch sensors 111, 112, 121, and 122 provided on rims 110 and 120 which are frame portions for fixing lenses.

Specifically, the touch sensors 111 and 112 are provided on an upper portion and a lower portion of the right rim 110, respectively, and the touch sensors 121 and 122 are provided on an upper portion and a lower portion of the left rim 120, respectively.

The touch sensors 111, 112, 121, and 122 are means for receiving a user operation such as touching, dragging, flicking, sliding, and the like, and may adopt various method such as capacitive or resistive.

Due to a limit of a rim width, the touch sensors 111, 112, 121, and 122 are arranged in one (1) dimension such that they are configured to receive only 1-dimensional input (that is, left and right input). However, when a wide rim is implemented, the touch sensors 111, 112, 121, and 122 may be arranged in two (2) dimensions such that they are configured to receive 2-dimensional input (that is, forward and backward input and left and right input).

The touch sensors 111, 112, 121, and 122 may be named according to their respective locations as follows:

1) The touch sensor 111 provided on the upper portion of the right rim 110 is referred to as a touch sensor-RU 111,

2) the touch sensor 112 provided on the lower portion of the right rim 110 is referred to as a touch sensor-RL 112,

3) the touch sensor 121 provided on the upper portion of the left rim 120 is referred to as a touch sensor-LU 121, and

4) the touch sensor 122 provided on the lower portion of the left rim 120 is referred to as a touch sensor LL 1222.

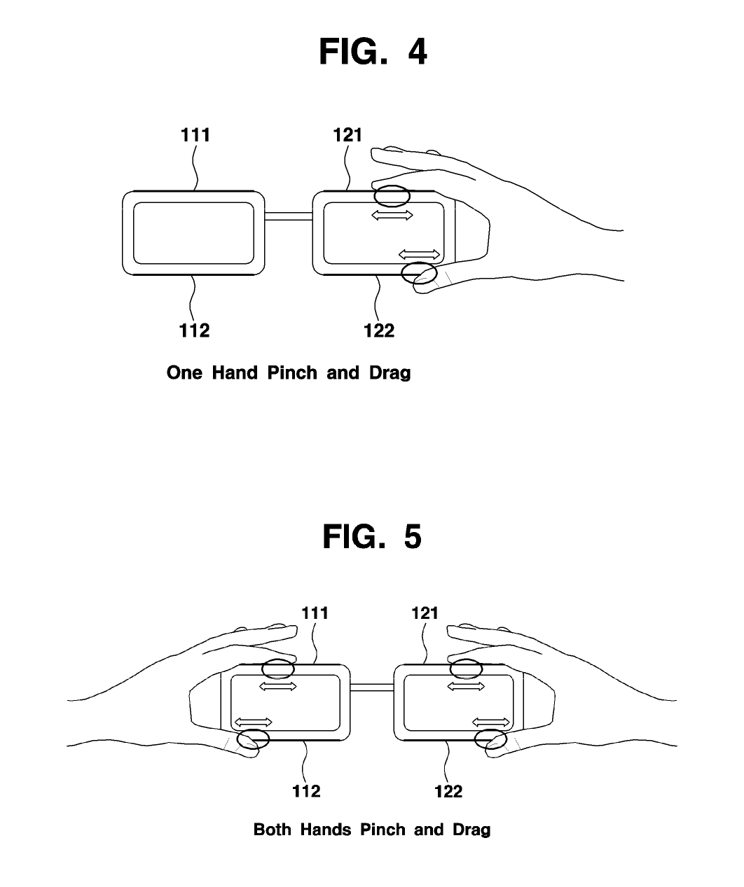

Hereinafter, user operations through the glasses type device according to an exemplary embodiment of the present invention will be explained with reference to FIGS. 4 to 7.

The user generates output change of the sensors with time by using a means for changing capacitance or pressure of a corresponding location, such as a finger, on the sensors arranged on the rim of the glasses, like an operating method of a general touch sensor. A reader in a processor reads out the output change and performs following various operations (see FIG. 9).

FIG. 4 is a view showing a one hand pinch and drag (P&D) operation. The one hand P&D operation refers to an operation of pinching the touch sensor-LU 121 and the touch sensor-LL 122 between thumb and first finger of user's left hand and then dragging from side to side as shown in FIG. 4.

The one hand P&D operation may be used to adjust a physical quantity of the glasses type device (e.g., to adjust a volume), move a highlight/pointer from side to side, adjust an application (zoom in/out a screen or scrolling), and the like.

The one hand P&D operation can be achieved by performing P&D with respect to the touch sensor-RU 111 and the touch sensor-RL 112 with user's right hand, instead of performing P&D with respect to the touch sensor-LU 121 and the touch sensor-LL 122 with user's left hand.

FIG. 5 is a view showing a both hands P&D operation. As shown in FIG. 5, the both hands P&D operation refers to an operation of pinching the touch sensor-LU 121 and the touch sensor-LL 122 with user's left hand and pinching the touch sensor-RU 111 and the touch sensor-RL 112 with user's right hand, and then dragging the left or right hand.

The both hands P&D operation is useful for 2-dimensional input. For example, in the both hands P&D operation, the dragging by the right hand may be used to input an X-axis direction moving command of the pointer, and the dragging by the left hand may be used to input a Y-axis direction moving command of the pointer. Of course, the dragging by the left hand may be used to input the X-axis direction moving command and the dragging by the right hand may be used to input the Y-axis direction moving command.

The operation of touching/double-touching the touch sensor-LU 121 with user's left hand may be implemented as an operation for selecting/executing an icon/menu/application, which corresponds to left-clicking of a PC mouse. In addition, the operation of touching/double-touching the touch sensor-RU 111 with user's right hand may be implemented as an operation for calling a sub-menu, which corresponds to right-clicking of the PC mouse.

Furthermore, the technical idea of the present invention can be applied when touching/double-touching the touch sensor-LU 121 is substituted with touching/double-touching the touch sensor-LL 122 or touching/double-touching the touch sensor-RU 111 is substituted with touching/double-touching the touch sensor-RL 112.

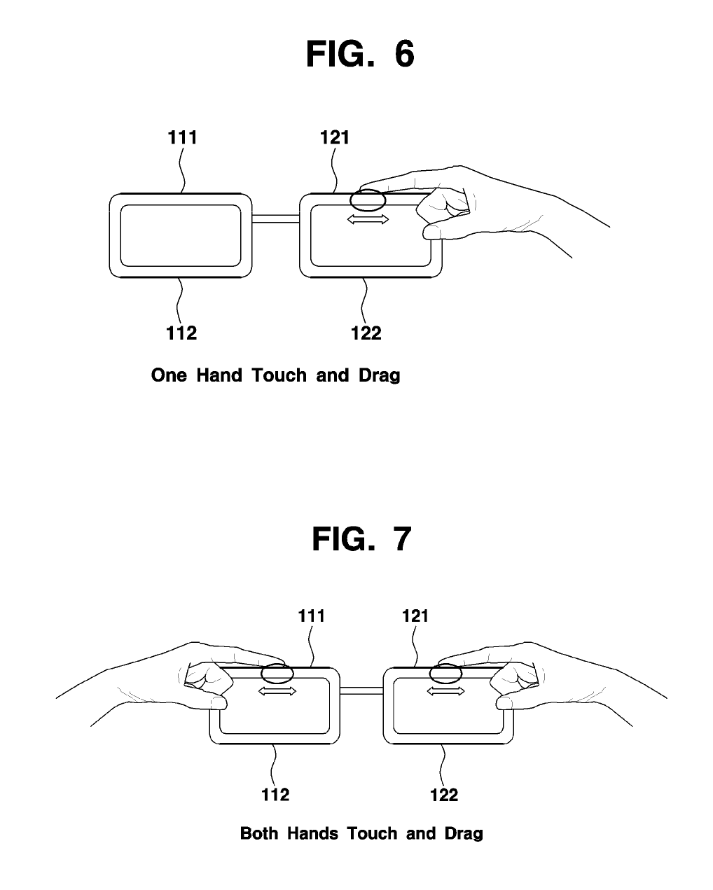

FIG. 6 is a view showing a one hand Touch and Drag (T&D) operation. As shown in FIG. 6, the one hand T&D operation refers to an operation of touching the touch sensor-LU 121 with the first finger of user's left hand and then dragging from side to side.

The one hand T&D operation may be performed to execute a specific object of the glasses type device (an application, icon, and the like) and perform a detailed manipulation (moving/enlarging/scrolling/selecting a menu). The executing is achieved by touching or double touching and the detailed manipulation is achieved by scrolling by dragging.

The one hand T&D operation may be performed through the touch sensor-RU 111, the touch sensor-RL 112, and the touch sensor-LL 122 in addition to the touch sensor-LU 121.

FIG. 7 is a view showing a both hands T&D operation. As shown in FIG. 7, the both hands T&D operation refers to an operation of touching the touch sensor-LU 121 with the first finger of user's left hand and touching the touch sensor-RU 111 with the first finger of user's right hand and then dragging the left hand and/or right hand from side to side while still touching.

The both hands T&D operation may be performed to zoom in/out by multi-touch, to drive two buttons independently in a game, or to input “CTRL+key” or “SHIFT+key” in inputting a menu or a text.

The both hands T&D operation may use the touch sensor-RL 112 and the touch sensor-LL 122 instead of the touch sensor-RU 111 and the touch sensor-LU 121.

Up to now, the user operations through the glasses type device according to the exemplary embodiment of the present invention have been described with reference to FIGS. 4 to 7, but the operations and the functions accompanied with them are merely examples for the convenience of understanding and explanation.

The technical idea of the present invention can be applied when the operations and the functions are substituted with other operations and other functions.

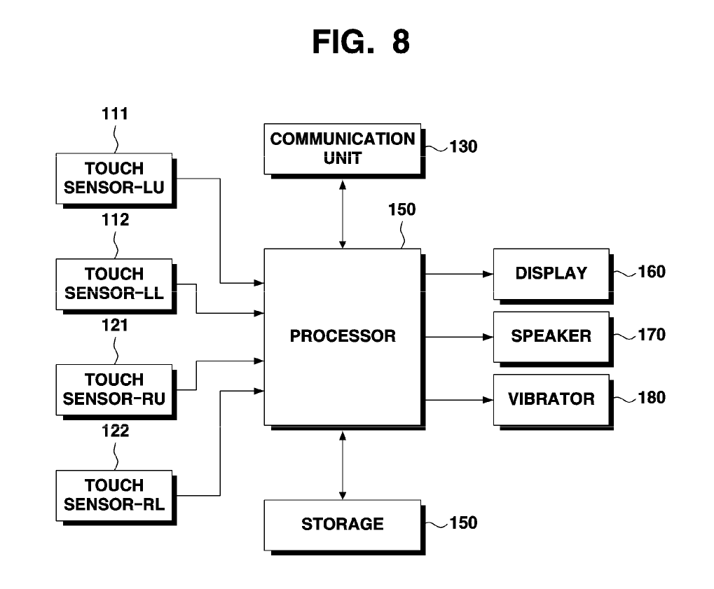

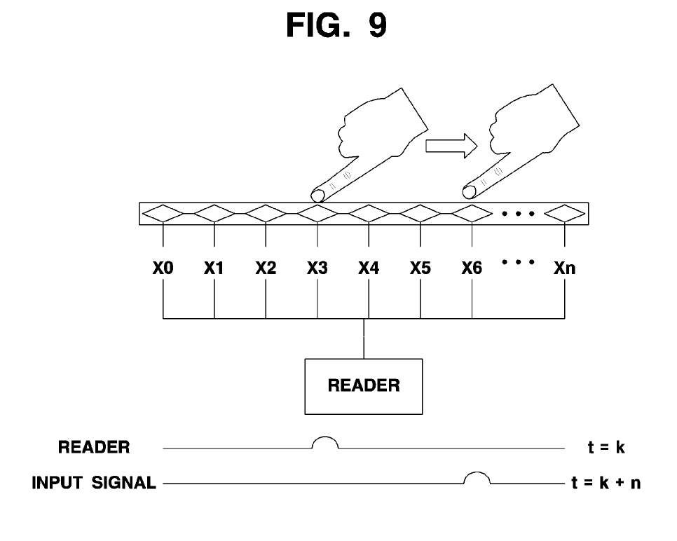

FIG. 8 is a block diagram of an interior of the glasses type device of FIG. 1. The glasses type device according to an exemplary embodiment of the present invention includes touch sensors 111, 112, 121, and 122, a communication unit 140, a processor 140, a storage 150, a display 160, a speaker 170, and a vibrator 180, as shown in FIG. 8.

The communication unit 130 is a communicating means for communicating with an external device or accessing an external network, and the storage 150 is a storage medium in which firmware necessary for driving the glasses type device and various applications are stored/installed.

The display 160, the speaker 170, and the vibrator 180 are means for providing various interactions to the user. All of these may not be provided and may be provided selectively.

The display 160 may be a see-through type display or a see-closed type display.

When a user operation is input through the touch sensors 111, 112, 121, and 122, the processor 140 performs a corresponding function and feeds a result of the performing back to the user through the display 160, the speaker 170, and the vibrator 180.

The processor 140 may communicate with an external device through the communication unit 130 to perform a user command, when necessary.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A glasses type device comprising:
a frame of a glasses shape;
a touch sensor provided on a rim of the frame; and
a processor configured to process a user operation which is input through the touch sensor.

2. The glasses type device of claim 1, wherein the touch sensor comprises:
a first touch sensor provided on a first rim; and
a second touch sensor provided on a second rim.

3. The glasses type device of claim 2, wherein the user operation comprises an operation of touching at least one of the first touch sensor and the second touch sensor and an operation of touching and dragging at least one of the first touch sensor and the second touch sensor.

4. The glasses type device of claim 2, wherein the first touch sensor comprises:
a 11^{th} touch sensor provided on an upper portion of the first rim; and
a 12^{th} touch sensor provided on a lower portion of the first rim.

5. The glasses type device of claim 4, wherein the user operation comprises an operation of pinching the 11^{th} touch sensor and the 12^{th} touch sensor with one hand and then dragging.

6. The glasses type device of claim 4, wherein the second touch sensor comprises:
a 21^{st} touch sensor provided on an upper portion of the second rim; and
a 22^{nd} touch sensor provided on a lower portion of the second rim.

7. The glasses type device of claim 6, wherein the user operation comprises an operation of pinching the 11^{th} touch sensor and the 12^{th} touch sensor with one hand and pinching the 21^{st} touch sensor and 22^{nd} touch sensor with the other hand, and then dragging at least one of the both hands.

8. The glasses type device of claim 6, wherein the user operation comprises an operation of touching one of the 11^{th} touch sensor and the 12^{th} touch sensor with one hand and touching one of the 21^{st} touch sensor and the 22^{nd} touch sensor with the other hand, and then dragging at least one of the both hands.

9. A user input method comprising:
receiving a user operation through a touch sensor provided on a rim of a frame of a glasses shape; and
processing the received user operation.
